(19) United States
(12) Patent Application Publication
(10) Pub. No.: US 2013/0122594 A1
(43) Pub. Date: May 16, 2013

(54) DETERMINATION OF COMPONENT TEMPERATURE

(71) Applicant: Rolls-Royce PLC, London (GB)

(72) Inventors: Michael Gareth HUGHES, Derby (GB); Thomas DANVERS, Wirksworth (GB); Stuart BULLOCK, Derby (GB); Colin BIRD, Derby (GB)

(73) Assignee: ROLLS-ROYCE PLC, London (GB)

(21) Appl. No.: 13/660,280

(22) Filed: Oct. 25, 2012

(30) Foreign Application Priority Data
Nov. 10, 2011 (GB) 1119364.6

(51) Int. Cl. G01N 21/65; G01N 31/00

(52) U.S. Cl. 436/7; 422/82.12; 422/82.05

(57) ABSTRACT

Determining a temperature experienced by a region of a component comprising the steps of: providing a component with a temperature sensitive detection material in a first state and exhibiting a first chemical characteristic prior to its exposure to a thermal environment; exposing the component to a thermal environment such that the detection material is converted to a different state in which at least one region of the detection material exhibits at least one chemical characteristic different to the first chemical characteristic; identifying at least one region of the component in which the detection material exhibits the at least one chemical characteristic which is different to the first chemical characteristic; and determining the temperature experienced by the component in the or each region by relating the detection material chemical characteristic in the or each region to a temperature value by reference to a correlation of detection material chemical characteristic and temperature.

This invention claims the benefit of UK Patent Application No. 1119364.6, filed on 10 Nov. 2011, which is hereby incorporated herein in its entirety.

### FIELD OF THE INVENTION

The present disclosure relates to a method of determining a temperature experienced by a region of a component.

### BACKGROUND TO THE INVENTION

It is desirable to determine temperatures experienced by engines and other machinery during their operation. This may be done with sensors which monitor temperature during operation of the machinery. Alternatively temperature sensitive coatings may be applied to one or more components under scrutiny.

Such coatings are known as thermal paints, temperature indicating paints or irreversible temperature indicating paints. These coatings are usually interpreted manually by eye, as described, for example, in U.S. Pat. No. 6,434,267. The described procedure is time consuming and highly dependent on the subjective colour reception of the operator. U.S. Pat. No. 6,434,267 describes a complex electronic system for interpreting material colour changes in order to determine temperature experienced by a component. This system relies on reading colours which may be contaminated or otherwise affected by exposure to an operational machine environment, for example pollutants which may stain or become attached to the component surface.

Hence a method for determining the temperature experienced by a component which is less sensitive to contamination of the coating is highly desirable.

### STATEMENTS OF INVENTION

Accordingly there is provided a method of determining a temperature experienced by a region of a component, the method comprising steps of:
i) providing a component with a temperature sensitive detection material, the detection material being in a first state and exhibiting a first chemical characteristic prior to exposure to a thermal environment;
ii) exposing the component to a thermal environment such that the detection material is converted to a different state in which at least one region of the detection material exhibits at least one chemical characteristic different to the first chemical characteristic;
iii) identifying at least one region of the component where the detection material exhibits the at least one chemical characteristic different to the first chemical characteristic;
iv) determining the temperature experienced by the component in the oreach region by relating the detection material chemical characteristic in the or each region to a temperature value by reference to a correlation of detection material chemical characteristic and temperature.

Accordingly there is also provided a system for determining a temperature experienced by a region of a component, the component provided with a temperature sensitive detection material, the detection material being in a first state and exhibiting a first chemical characteristic prior to exposure to a thermal environment; and which in use is exposed to a thermal environment such that the detection material is converted to a different state in which at least one region of the detection material exhibits at least one chemical characteristic different to the first chemical characteristic; the system comprising: a detector for identifying the different chemical characteristic(s) of the detection material following exposure of the component to the thermal environment, and a processor for determining the temperature experienced by the component in the or each region by relating the detection material chemical characteristic in the or each region to a temperature value by reference to a correlation of detection material chemical characteristic and temperature; wherein the or each chemical characteristics of the detection material are identified at room temperature.

Hence there is provided a method for determining the temperature experienced by a component coated with thermally sensitive paint which examines the change in chemical composition of the paint and is independent of the visible colour of the paint.

Other aspects of the invention provide devices, methods and systems which include and/or implement some or all of the actions described herein. The illustrative aspects of the invention are designed to solve one or more of the problems herein described and/or one or more other problems not discussed.

### BRIEF DESCRIPTION OF THE DRAWINGS

Examples of the present disclosure will now be described with reference to the accompanying drawings, in which:

FIG. 1 is a diagrammatic representation of a component with a detection material applied prior to exposure to a thermal environment;

FIG. 2 is a shows diagrammatic representation of an analysis equipment component used for the analysis of the component; and

FIG. 3 is a diagrammatic representation of the component of FIG. 1 with a detection material applied post exposure to a thermal environment.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION

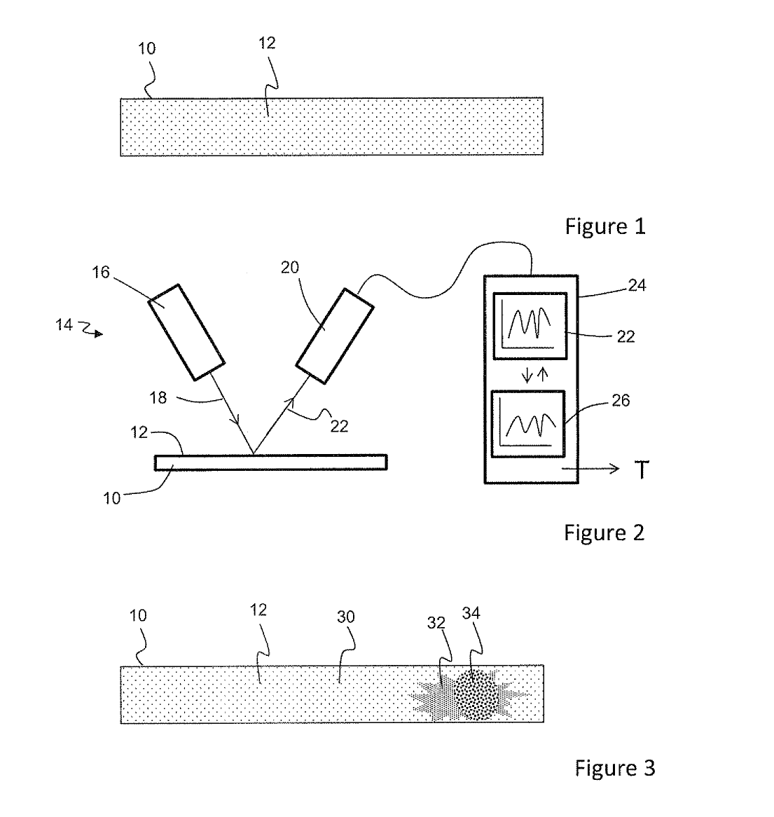

Shown in FIG. 1 is a component 10 with a temperature sensitive detection material coating 12 applied to it. The detection material coating 12 has a substantially consistent composition over the area it is applied. In the example shown the detection material coating 12 is applied to the whole of the component 10. In alternative examples the coating 12 may be applied to a selected region of the component 10, but not the whole of the component 10. The detection material 12 may be a thermal paint configured to permanently change from a first state having a first chemical composition to a different state having a different chemical composition at a known temperature. That is to say the detection material 12 may be a thermal paint configured to undergo a permanent change in chemical composition at a known temperature.

Shown in FIG. 2 is a representation of a system 14 for identifying chemical characteristic(s) of the detection material 12. The system 14 comprises a laser 16 for directing coherent light 18 of a specific wavelength to the surface of the coated component 10, and a detector 20 for the detection of spectra 22 emitted from the surface of the coated component 10. The spectra 22 is indicative of a chemical characteristic of the detection material 12. The detector 20 is linked to a processor 24 (e.g. computer). The processor 24 is configured to relate the spectra 22 (i.e. the chemical characteristic) to a temperature value T by reference to a correlation 26 of detection material chemical characteristic and temperature T. The system 14 is operable at room temperature. The detector may comprise a RAMAN spectrometer.

The system 14 described above may be used as part of a method to determine a temperature experienced by a region of a component 10. As described above, the component 10 is first provided with a temperature sensitive detection material 12. The detection material 12 is in a first state and exhibits a first chemical characteristic 30 prior to exposure to a thermal environment. In FIG. 1 the first chemical characteristic 30 is presented diagrammatically as an evenly distributed dotted pattern. The term “thermal environment” is used to mean a location where the component 10 is exposed to heat. For example, if the component 10 is an engine component, the component 10 may be located in its normal operating location and the engine run to a set of conditions to expose the component 10 to operational the range and gradient of temperatures.

The component 10, once in position, is then exposed to the thermal environment such that the detection material 12 may be converted to a different state in which at least one region of the detection material 12 exhibits at least one chemical characteristic 32 different to the first chemical characteristic 30. In the example shown in FIG. 3, the detection material exhibits two chemical characteristics, identified as 32, 34, which are different to the first chemical characteristic 30. The analysis system 14 scans over the surface of the component 10 and the data obtained is used to identify a region 32 or regions 32,34 of the component 10 where the detection material exhibits chemical characteristics different to the first chemical characteristic. The chemical characteristic is determined by using a Spectroscopy technique to analyse the chemical composition of the detection material 12. The detector 20 communicates the spectra 22 obtained for the different regions to the processor 24 and determines the temperature experienced by the component 10 in the or each region 32,34 by relating the detection material chemical characteristic 30,32,34 in the or each region to a temperature value T by reference to the correlation 26 of detection material chemical characteristic 30,32,34 and temperature T. The value of the temperature may be output in some suitable form.

In examples where a plurality of regions 32,34 of the component 10 are analysed, a thermal map is produced which indicates the range of temperatures T experienced by the component 10. The method, and system, are operable at room temperature. That is to say the or each characteristics 30,32,34 of the detection material 12 are identified at room temperature. Hence the method and system are intended for examining the component when the engine is non operational. The component may be examined in situ, for example using boroscope equipment to deliver the laser and detect emitted light. Alternatively the component may be removed from the engine for analysis.

The correlation 26 of detection material chemical characteristic 30,32,34 and temperature T is predetermined and comprises a library, database, look up table and/or algorithm.

The algorithm may be derived using a machine learning supervised classifier type technique trained using a library of detection material samples pre-heated to known temperatures. A description of such techniques can be found in Pattern Recognition and Machine Learning by Christopher M. Bishop (Published in 2007 by Springer, ISBN-13: 978-0387310732).

The correlation 26 may be derived from at least one detection material sample heated to a known temperature under controlled conditions to provide a calibration sample. For example a plurality of calibration coupons (i.e. the “samples”) are coated with a specific thermal paint. The coupons are then exposed to a variety of temperatures (e.g. at 10° C. intervals) for known exposure times (e.g. 2, 5, 10, 30 and 60 minutes), chosen to cover the intended operating conditions of the paint. As the irreversible chemical reaction, which results in a calibratable colour change in the paint, is dependent on both temperature and duration at temperature the calibration process produces a range of possible outcomes from thermal exposure. Once the coupons have returned to room temperature a Raman spectra is captured from each and grouped together under the duration of exposure. This process captures the changes in the chemical compounds present in the paint as the paint is exposed to increasing temperatures, which is represented by changes in features present in the Raman spectra.

The inventors have found that some temperature sensitive detection material compositions produce a clearer Raman Spectra than others, which is due to their different chemical compositions. There are two main mechanisms which control how well a specific detection material responds. The first is the intensity of Raman response from the detection material. The resulting Raman response must be of sufficient intensity to be observed over noise present in the spectra. That is to say, a Raman response produced by a specific compound may change with temperature, but may be too weak to be clearly distinguished from spectra produced by the other compounds present in the detection material, or the general signal noise inherent in the method. If this is the case, then analysis to determine chemical change, and hence temperature, may be unachievable. The second mechanism is the fluorescent response of some compounds, which releases a large amount of photons that swamp the detector and prevent in the Raman spectra from being observed. The fluorescent response can be avoided by increasing the laser frequency, however doing so may reduce the intensity of the Raman response, thus interfering with the first mechanism described above. Of the available range of temperature sensitive detection material those preferred contain compounds which produce a better Raman response or contain less compounds which produce a fluorescent response.

For a temperature sensitive detection material described in European Patent Number EP1288267 (Rolls-Royce plc) the use of a laser wavelength of 633 nm produces an acceptable Raman response.

For a temperature sensitive detection material described in European Patent Number EP1288266 (Rolls-Royce plc) the use of a laser wavelength of 785 nm produces an acceptable Raman response.

A temperature sensitive detection material comprising lead and calcium carbonate produce an acceptable Raman response when exposed to wavelengths of 633 nm (for example He—Ne), 830 nm and/or 1064 nm (for example Nd:YAG).

Hence the method and system described above enables a technique of examining thermal paints change in chemical composition, rather than their change in colour, to reveal the temperature experienced by the component.

The method and system herein described is a non-destructive technique, and this has the advantage of being able to identify trace amounts of chemicals without compromising or polluting the chemicals on the component 10.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person of skill in the art are included within the scope of the invention as defined by the accompanying claims.

What is claimed is:

1. A method of determining a temperature experienced by a region of a component, the method comprising steps of:
i) providing a component with a temperature sensitive detection material, the detection material being in a first state and exhibiting a first chemical characteristic prior to exposure to a thermal environment;
ii) exposing the component to a thermal environment such that the detection material is converted to a different state in which at least one region of the detection material exhibits at least one chemical characteristic different to the first chemical characteristic;
iii) identifying at least one region of the component where the detection material exhibits the at least one chemical characteristic different to the first chemical characteristic;
iv) determining the temperature experienced by the component in the or each region by relating the detection material chemical characteristic in the or each region to a temperature value by reference to a correlation of detection material chemical characteristic and temperature.

2. The method of claim 1, wherein the detection material is provided in a coating applied to the component.

3. A method as claimed in claim 2 wherein the detection material is a thermal paint configured to undergo a permanent change in chemical composition at a known temperature.

4. A method as claimed in claim 3 wherein the detection material is a thermal paint configured to permanently change from a first state having a first chemical composition to a different state having a different chemical composition at a known temperature.

5. A method as claimed in claim 1 wherein the characteristic is determined by using a Spectroscopy technique to analyse the chemical composition of the detection material.

6. A method as claimed in claim 5 wherein the Spectroscopy technique is RAMAN spectroscopy.

7. A method as claimed in claim 1 wherein a plurality of regions of the component are analysed to produce a thermal map indicating the range of temperatures experienced by the component.

8. A method as claimed in claim 1, wherein the or each characteristics of the detection material are identified at room temperature.

9. A method as claimed in claim 1 wherein the correlation of detection material chemical characteristic and temperature is predetermined and comprises a library, database, look up table and/or algorithm.

10. A method as claimed in claim 9 wherein the correlation is derived from at least one detection material sample heated to a known temperature.

11. A system for determining a temperature experienced by a region of a component, the component provided with a temperature sensitive detection material, the detection material being in a first state and exhibiting a first chemical characteristic prior to exposure to a thermal environment; and which in use is exposed to a thermal environment such that the detection material is converted to a different state in which at least one region of the detection material exhibits at least one chemical characteristic different to the first chemical characteristic;
the system comprising: a detector for identifying the different chemical characteristic(s) of the detection material following exposure of the component to the thermal environment, and a processor for determining the temperature experienced by the component in the or each region by relating the detection material chemical characteristic in the or each region to a temperature value by reference to a correlation of detection material chemical characteristic and temperature; wherein the or each chemical characteristics of the detection material are identified at room temperature.

12. A system as claimed in claim 11 where the detector comprises a RAMAN spectrometer.

13. A system as claimed in claim 11 where the detection material is a thermal paint configured to permanently change from a first state having a first chemical composition to a different state having a different chemical composition at a known temperature.
